(19) United States
(12) Patent Application Publication
(10) Pub. No.: US 2017/0355222 A1
(43) Pub. Date: Dec. 14, 2017

(54) IMPROVED PAINT ROLLER PAINT TRAY

(71) Applicant: Dee Lynn ANDRESEN, Elizabeth, CO (US)

(72) Inventor: Dee Lynn ANDRESEN, Elizabeth, CO (US)

(21) Appl. No.: 15/521,911

(22) PCT Filed: Nov. 16, 2015
(86) PCT No.: PCT/IB15/58856

§ 371 Date: Apr. 26, 2017

Related U.S. Application Data
(60) Provisional application No. 62/080,036, filed on Nov. 14, 2014.

(51) Int. Cl. B44D 3/12; B05C 17/02

(52) U.S. Cl. CPC B44D 3/126; B05C 17/0245

(57) ABSTRACT

An improved paint roller tray includes a paint roller tray and a pair of strips. The pair of strips is mounted onto the ramp of the paint roller tray. The pair of strips is positioned offset and parallel to each other in order to create a recessed space between the pair of strips and the ramp. The configuration of pair of rollers on the ramp allows the improved paint roller to wipe the excess paint from a paint roller.

The current application claims priority to U.S. provisional patent application Ser. No. 62/080,036 filed on Nov. 14, 2014.

### FIELD OF THE INVENTION

The present invention relates generally to paint trays of various sizes for use with paint rollers of various sizes with several improvements including a recessed area of the ramp to allow more paint to be distributed to the center of the roller cover than to the sides. Strips that also clean excess paint and drips from the roller ends and bumpers to wipe any remaining excess paint off the ends of the roller, an overall larger well to hold more paint and additional paint storage in ⅓ of the ramp which is depressed to the depth of the well. Side roller arm rests, adding another position holding the roller out of the paint further.

### BACKGROUND OF THE INVENTION

Painting is an activity which has been performed by human beings since before recorded history. Paintings made by humans on cave walls have been found dating back to as early as 40,000 BC. These early paintings often depicted animals and hunting parties, and may have served communication, decoration, or spiritual purposes. Since then, painting has had an important role in expression and decoration for nearly every culture of the world. Techniques and technologies used in painting were often spurred by painters employed by aristocrats to decorate their homes and properties, and was inextricably linked with architecture until the development of easel painting in the renaissance.

Despite the long history of painting, the painting tools which may be purchased at hardware stores and used by homeowners and professionals for painting large surfaces such as walls and ceilings leave much to be desired. In particular, paint trays intended for use with paint rollers have many opportunities for improvement. Paint trays intended for use with rollers which are currently available on the market have shallow, short wells which do not hold much paint. These conventional trays also have flat ramps which, in conjunction with the back and forth rolling action in the tray, move paint towards the sides of the roller cover. This outward motion results in excess paint collecting at the ends of the roller. This causes the paint to be applied unevenly to the painting surface, and leads to splatter when the roller is turned sideways, such as when painting around baseboards. Also, currently available paint trays do not provide a good location to place the roller arm sufficient out of the paint when not in use. Currently available trays are also not easily held or transported.

These shortcomings have been observed by the inventor of the present invention in her work in renovating, restoring, and remodeling homes. She has developed several novel components and improvements which address these deficiencies. It is the objective of the present invention to introduce a new and improved paint roller paint tray which enables middle section of the roller sleeve to expand and absorb the paint freely, and at the same time cleans the ends of the roller sleeve to alleviate excess paint and splatter that otherwise accumulates at these ends. This allows the user to load paint less frequently onto the paint sleeve and also cleans up the roller sleeve ends, avoiding excess paint and splatter. The apparatus of the present invention enables the user to more easily achieve an even distribution of paint on the roller, to easily and conveniently hold the tray, to fill the tray with more paint, and to use the tray with greater confidence.

### BRIEF DESCRIPTION OF THE DRAWINGS

FIG. 1 is a perspective view of the apparatus of the present invention.

FIG. 2 is an alternate perspective view of the apparatus of the present invention.

FIG. 3 is a plain top view of the apparatus of the present invention.

FIG. 4 is plain bottom view of the apparatus of the present invention.

FIG. 5 is a plain front view of the apparatus of the present invention.

FIG. 6 is a plain rear view of the apparatus of the present invention.

FIG. 7 is a plain side view of the apparatus of the present invention.

FIG. 8 is an alternate plain side view of the apparatus of the present invention.

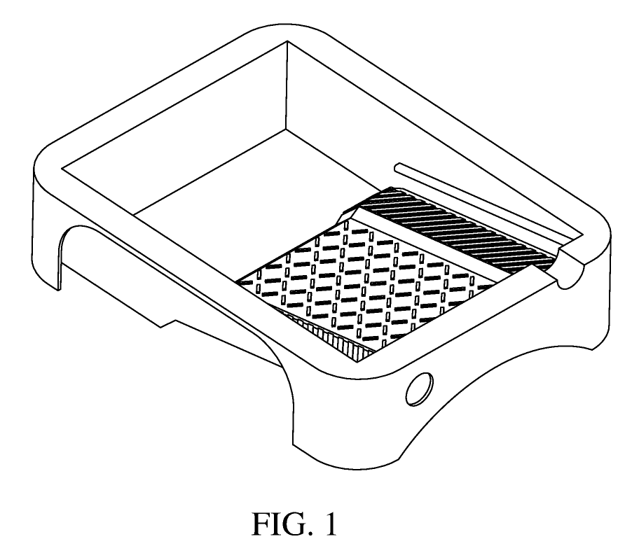

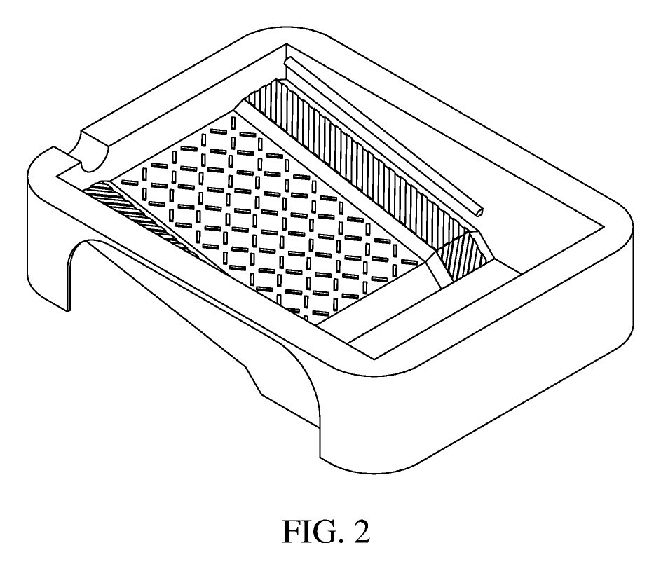

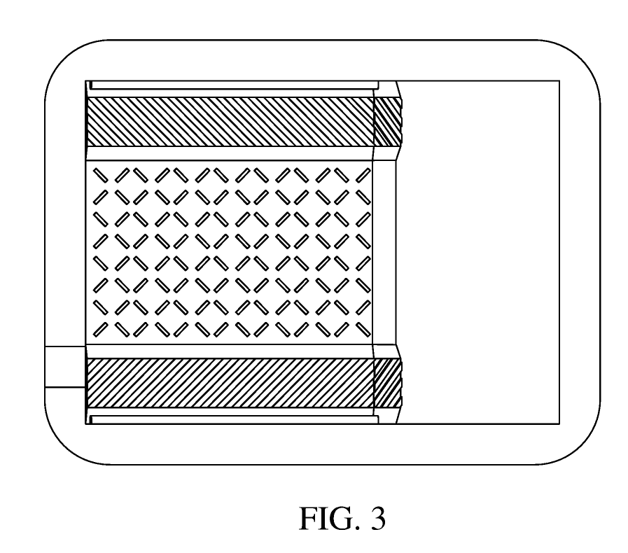

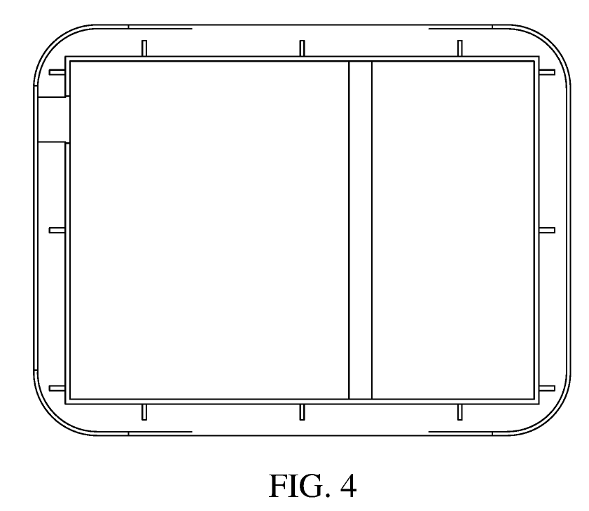

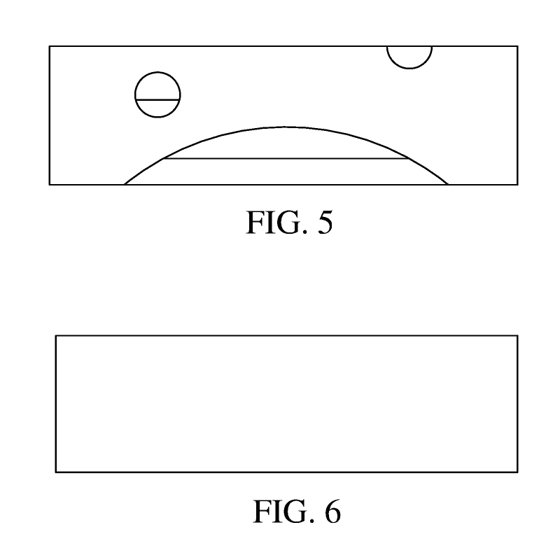

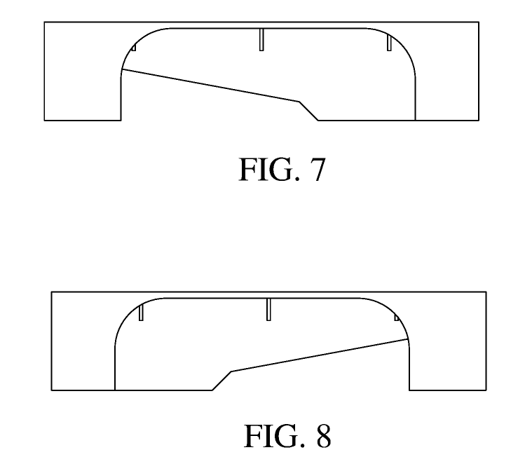

### DETAIL DESCRIPTIONS OF THE INVENTION

All illustrations of the drawings are for the purpose of describing selected versions of the present invention and are not intended to limit the scope of the present invention.

An improved paint roller paint tray further comprises a well, a ramp, walls, a lip, bumpers, and feet.

The well is the region in which paint is pooled in the tray. The well has a flat bottom, is bounded on three sides by walls, and on a fourth side by the lower angled ramp face. The well occupies approximately one third of the inner space of the tray. The flat bottom of the well is slightly extended compared to conventional paint trays familiar to those skilled in the art. In a preferred embodiment, the flat bottom of the well would be extended by one half inch. This extension allows the apparatus to be filled with more paint, allowing greater time between refilling.

The ramp occupies the remaining inner space of the tray, rising at an angle from the flat bottom of the well to the upper wall. The constituent components of the ramp form a recessed space in the center which allows the roller cover to expand and absorb additional paint, allowing more painting time between reapplication to the roller.

The ramp further comprises a lower angled ramp face, an upper angled ramp face, raised runners and a ramp tread. The lower angled ramp face is a short section which rises at a sharp angle from the well. The upper angled ramp face is the longer main portion of the ramp which extends to the upper wall. The angle of ascent of the upper angled ramp to the upper wall is greater than the angle of conventional paint trays familiar to those skilled in the art. The width of the lower angled ramp face is the same as the width of the upper angled ramp face, and is greater than the width of the roller. Therefore the roller has clearance to move at least slightly in a transverse direction on the ramp. The raised runners are means by which to increase the amount of paint which is distributed onto the center of the roller, and to decrease the amount of paint which is distributed onto the ends of the roller when it is rolled along the ramp. The raised runners are generally flat strips which extend along the length of the ramp parallel to the side walls. In one possible embodiment, the raised runners have a short rectangular cross section. The raised runners further comprise lower runners, upper runners, runner treads, and sloped sides. The lower runners are located on the lower angled ramp, and the upper runners are located on the upper angled ramp. The raised runners may be flush with the side walls, or may be slightly offset from the side walls. The raised runners may be fabricated by either adding more material to the ramp, or by creating recessed areas of the ramp. For instance, two strips may be fixedly attached to the ramp, or the center and far sides of the ramp may be slightly dropped, leaving two strips which are raised with respect to the rest of the ramp. The runner treads are textured surfaces of increased friction on the top of the runner which cause the roller of the roller to spin when the roller is pushed along the ramp. The angle of the runner treads causes excess paint left on the raised runners to drip down onto the sloped sides of the raised runners. The runner treads may comprise any texture or geometry. In one possible embodiment, the runner treads may comprise a plurality of ridges angled downwards towards the center of the ramp. The ramp tread is the textured surface of the upper angled ramp face which causes the roller of the roller to spin when pushed along the ramp. The ramp tread may comprise any shape or geometry including a tiled pattern, a tread plate pattern, or a picture with extensive detail such as a stylized representation of musical notes, clefs, and a staff. The sloped sides of the raised runners induce paint to return from the raised runners to the well by way of the ramp. The sloped sides of the raised runners are angled surfaces which extend downward from the sides of the ramp tread to the face of the ramp. The sloped sides between the raised runners and the side walls form drain ditches. The drain ditches are recessed gutters on either side of the ramp, which are approximately the width of a pencil which direct paint back to the well.

The walls surround the ramp and the well, and prevent paint from spilling out of the tray onto the floor. The walls may be vertical, or may slightly draft outward from bottom to top. The walls further comprise a first side wall, a second side wall, a lower wall, and an upper wall. The lower wall is located at the end of the well opposite the ramp. The upper wall is located at the upper end of the ramp. The height of the walls may be greater than the relative height of of conventional paint trays familiar to those skilled in the art. This will prevent paint from spilling out of the apparatus in the event that the apparatus is slightly overfilled with paint.

The lip runs along the upper edges of the walls, and provides additional stability to the apparatus, as well as improved prevention of paint spills and drips. The lip further comprises a roller rest, and a plurality of ribs. The roller rest is the location of the apparatus in which the handle of the roller may sit when not in use. The roller rest is an indented space with a half-circular cross section in the top of the lip on the upper wall, approximately halfway between the center of the upper wall and the side wall. The location of the roller rest brings the roller to the top of the ramp and out of the paint well when not in use, so that it does not absorb paint when not in use. This prolongs the life of the cover, and decreases paint waste. In a preferred embodiment, the corners of the lip would be rounded to improve the stability of the apparatus by allowing the feet to partially wrap around the sides, and to eliminate possible stress concentrations at sharp corners. The ribs are structural reinforcing means which prevent the lip from bending with respect to the wall. The ribs may comprise trusses between the lower surface of the lip and the outer faces of the walls.

The bumpers are optional components that make contact with the side edges of the roller of a paint roller which is rolled along the ramp, and wipe excess paint from the side edges of the roller. The bumpers are narrow, straight poles which may comprise a rectangular or circular cross section. The bumpers are located on the first side wall and second side wall, and run parallel to the upper angled ramp face for most of the length of that ramp face. The distance between the bumpers and the upper angled ramp face must be such that the wire which attaches the handle to the roller stays above the bumpers, but the roller cover makes contact with the raised runners and ramp tread. Therefore the distance between the bumpers and the ramp will be determined by the radius of the roller which is expected to be used with the apparatus of the present invention.

The feet provide stability for the entire apparatus, and facilitate the user's holding and movement of the apparatus. The first foot is located at one end of the apparatus, near the upper wall. The second foot is located at the other end of the apparatus, near the lower wall. The feet extend downward from the edge of the lip to the surface upon which the apparatus has been placed. The feet may extend downward from the edge of the lip parallel to the walls, or may slightly draft outward from the lip to the surface upon which the apparatus has been placed. The cross section of each foot comprises a flat middle and curved sides. The flat middle extends along the lip near the upper or lower wall, and the curved sides extend along the curved edges of the lip and wrap partially around the side walls. The curved sides of each foot partially wrap around the side walls, and thereby prevent the apparatus from tipping sideways, and compensate for any decrease in structural integrity which may be caused by cutting out of the arch and the boom hole. The connection between the feet and the lip above the side walls are curved to eliminate possible stress concentrations at sharp corners. The first foot further comprises an arch and a boom hole. The arch is a curved cut out area along the bottom center of the first foot. The arch allows a user to hold the paint tray stably with the bottom surface of the well in their hand, and their forearm extending through the arch. The boom hole is a circular hole to which a boom or long handle may be hooked to allow the paint tray to be easily slid by a user at a distance. The boom hole is located on the side of the first foot opposite the roller rest.

The following describes some additional aspects of the present invention. The present invention has a diamond design on the strips in order to generate more traction on the roller. In addition, the present invention has a drop that is one-third of the ramp to the depth of the well in order to retain additional paint as an oversized well. The present invention also has three arm rests along the back edge, where two of the rests raise the roller further away from the paint than the center rest that is in the prior art. Moreover, the present invention has strips or runners that are approximately 3/16 to ¼ of an inch in height.

In addition, the present invention could be formed with two different methods of manufacturing. The first method of manufacturing is to mount two protrusions onto the ramp in order to form the pair of strips on the ramp. The second method of manufacturing is to depress the central portion of the ramp in order to form the pair of strips.

In conclusion, the strips or runners clean excess paint, which would otherwise create lines, whips and drips off the ends of the roller in the current tray configurations on the market. The back and forth rolling on the current ramps inhibits the rollers ability to expand and retain the paint in the center and pushes the paint to the ends where you do not need it creating drips, whips, and roller end lines on the walls. The depression in my tray works in conjunction with the strips, enabling the roller nap to fully expand, absorb and retain the paint in the center portion of the roller. This helps cure the problem of reloading paint over and over, keeping you on task on the wall twice as long meanwhile cleaning the ends of the excess paint. The additional paint storage in the well and ramp helps store extra paint, to reduce refilling the tray keeping you on task longer as well.

Although the invention has been explained in relation to its preferred embodiment, it is to be understood that many other possible modifications and variations can be made without departing from the spirit and scope of the invention.

What is claimed:

1. An improved paint roller tray comprises:
a paint roller tray;
a pair of strips;
the paint roller tray comprises a well, a ramp, and a plurality of lateral walls;
the ramp being connected adjacent to the well;
the plurality of lateral walls being perimetrically connected about the ramp and the well;
the plurality of strips being mounted along the ramp;
the plurality of strips being positioned parallel to each other; and
the plurality of strips being positioned offset from each other by the length of a typical paint roller.

2. The improved paint roller tray as claimed in claim 1 comprises:
the pair of strips being formed by depressing a center portion of the ramp.

3. The improved paint roller tray as claimed in claim 1 comprises:
a plurality of bumpers;
the plurality of bumpers being distributed around the plurality of lateral walls; and
the plurality of bumpers being internally connected to the paint roller tray.

4. The improved paint roller tray as claimed in claim 1 comprises:
a lip; and
the lip being connected along an upper edge of each of the plurality of lateral walls.

5. The improved paint roller tray as claimed in claim 1 comprises:
a plurality of feet; and
the plurality of feet being mounted beneath a bottom portion of the paint roller tray, wherein the bottom of the paint roller tray is formed from the ramp and the well.

6. The improved paint roller tray as claimed in claim 1 comprises:
a first plurality of traction features;
a second plurality of traction features;
the first plurality of traction features being connected onto and along one of the pair of strips; and
the second plurality of traction features being onto and along the other of the pair of strips.

7. The improved paint roller tray as claimed in claim 1 comprises:
a plurality of arm rests;
the plurality of lateral walls comprises a back wall;
the back wall being positioned adjacent to the ramp, opposite to the well;
the plurality of arm rests being integrated into an upper edge of the back wall; and
the plurality of arm rests being distributed along the back wall.
